(19) United States
(12) Patent Application Publication
(10) Pub. No.: US 2003/0060160 A1
(43) Pub. Date: Mar. 27, 2003

(54) Subharmonic carrier-canceling baseband/K upconverter system

(76) Inventors: Xiaojuen Yuan, San Diego, CA (US); Adrian Gilbert, Buena Park, CA (US); Shih-Chang Wu, Rancho Palos Verdes, CA (US); Christopher Whiteside, Torrance, CA (US); Walid Al-Bondak, Los Angeles, CA (US); Janaki R. Potukuchi, Rancho Palos Verdes, CA (US)

Correspondence Address: John A. Artz, Artz & Artz, P.C., Suite 250, 28333 Telegraph Road, Southfield, MI, 48034, US

(21) Appl. No.: 09/960,013

(22) Filed: Sep. 21, 2001

(51) Int. Cl. H04B 7/185

(52) U.S. Cl. 455/12.1; 455/43

(57) ABSTRACT

A subharmonic carrier-canceling baseband/K upconverter system uses a first splitter to separate an incoming RF signal into two equal components: in-phase (1) and quadrature (Q, 180 degrees delayed). A second splitter is used to separate a local oscillator signal into two equal components: in-phase (I) and quadrature (Q, 90 degrees delayed). A first subharmonic mixer is used to mix both I components, while a second subharmonic mixer is used to mix both Q components. The outputs of both mixers are then combined to produce an output RF signal having reduced second order harmonics close to said local oscillator frequency.

### TECHNICAL FIELD

The present invention relates generally to communication systems, and more particularly, to a subharmonic carrier-canceling baseband/K upconverter system.

### BACKGROUND ART

Satellites and other spacecraft are in widespread use for various purposes including scientific research and communications. These scientific and communications missions, however, cannot be accurately fulfilled without wireless communication between a ground station and the spacecraft. In many applications, the satellite relies upon a wireless communication to send and receive electronic data to perform attitude and position corrections, diagnostic status checks, communication calculations and other functions. Without accurate wireless communication, proper satellite function is hindered and at times adversely effected.

In a typical satellite receiver, it is desirable to reduce any undesirable effect of spurious signals by the use of appropriate line filters to selectively attentuate any spurious signals. Such circuitry increases the complexity of the receiver and decreases receiver performance. As technology improves, communications signals at higher and higher frequencies are possible. At higher frequencies, component insertion losses increase and components of any known type of mixer used at higher frequencies have a greater effect in limiting the sensitivity of the receiver.

In conventional frequency translation schemes, a signal in a frequency band (Input Band, or IB) is converted to another frequency band (Output Band, or OB). If the second harmonic of the local oscillator frequency (i.e., 0,2 spur) were close to the edge of OB, the filter required to reduce this spur level would be very expensive. It may even be impossible to filter it if it is too close to the edge of OB.

The disadvantages associated with these conventional spur-canceling techniques have made it apparent that a new type of spur canceling is needed. Preferably, the new spur canceller would allow inexpensive filtering of second order harmonics close to a local oscillator frequency. The present invention is directed to these ends.

### SUMMARY OF THE INVENTION

It is, therefore, an object of this invention to provide an improved and reliable subharmonic carrier-canceling baseband/K upconverter system. Another object of the invention is to allow inexpensive filtering of second order harmonics close to a local oscillator frequency.

In accordance with the objects of this invention, a subharmonic carrier-canceling baseband/K upconverter system system is provided. In one embodiment of the invention, a subharmonic carrier-canceling baseband/K upconverter system uses a first splitter to separate an incoming RF signal into two equal components: in-phase (I) and quadrature (Q, 180 degrees delayed). A second splitter is used to separate a local oscillator signal into two equal components: in-phase (I) and quadrature (Q, 90 degrees delayed). A first subharmonic mixer is used to mix both I components, while a second subharmonic mixer is used to mix both Q components. The outputs of both mixers are then combined to produce an output RF signal having reduced second order harmonics close to said local oscillator frequency.

The present invention thus achieves an improved subharmonic carrier-canceling baseband/K upconverter system. The present invention is advantageous in that it is capable of inexpensively filtering out second harmonics close to a local oscillator frequency.

Additional advantages and features of the present invention will become apparent from the description that follows and may be realized by means of the instrumentalities and combinations particularly pointed out in the appended claims taken in conjunction with the accompanying drawings.

### BRIEF DESCRIPTION OF THE DRAWINGS

In order that the invention may be well understood, there will now be described some embodiments thereof taken by way of example, reference being made to the accompanying drawings in which:

FIG. 1 is a perspective view of a satellite system having a subharmonic carrier-canceling baseband/K upconverter system in accordance with one embodiment of the present invention;

FIG. 2 is a block diagram of a subharmonic carrier-canceling baseband/K upconverter system according to the present invention; and

FIG. 3 is a block diagram of an alternative subharmonic carrier-canceling baseband/K upconverter system according to the present invention.

### BEST MODES FOR CARRYING OUT THE INVENTION

In the following Figures, the same reference numerals will be used to identify identical components of the various views. The present invention is illustrated with respect to a subharmonic carrier-canceling baseband/K upconverter system particularly suited for the aerospace field. However, the present invention is applicable to various and other uses that may require a subharmonic carrier-canceling baseband/K upconverter system.

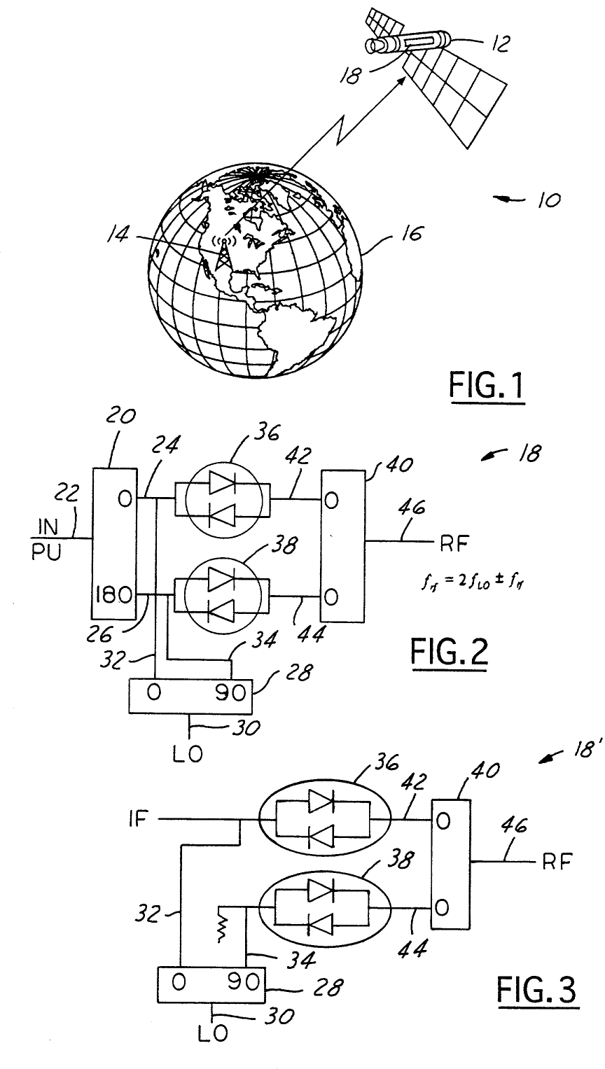

Referring to FIG. 1, a perspective view of a satellite system 10 having a subharmonic carrier-canceling baseband/K upconverter 18 in accordance with one embodiment of the present invention is illustrated. The satellite system 10 is comprised of one or more satellites 12 in communication with a ground station 14 located on the Earth 16. Each satellite includes a subharmonic carrier-canceling baseband/K upconverter system 18.

The present invention discloses a two-level spur canceling technique. The first level uses subharmonic mixers to reduce the magnitude of the 0,2 type spur (or the second harmonic of the local oscillator (LO) frequency) compared to conventional (or fundamental) mixing technique. The second level uses a unique spur-canceling scheme to further reduce the level of the 0,2 spur.

In conventional frequency translation schemes, a signal in a frequency band (Input Band, or IB) is converted to another frequency band (Output Band, or OB). If the second harmonic of the local oscillator frequency (i.e., 0,2 spur) is close to the edge of OB, the filter required to reduce this spur level is very expensive. It may even be impossible to filter it if it is too close to the edge of OB.

For example, up-conversion of a signal in the band of 20-480 MHz to 19,720-20,180 MHz band requires a local oscillator frequency of 19,700 MHz for a fundamental mixer or 9,850 MHz for a subharmonic mixer. For the fundamental conversion scheme, the level of the LO (at 19,700 MHz) leaking to the output would be relatively high and it is difficult to filter it out because it is only 20 MHz away form the band edge. For the subharmonic mixer, the level of the 19,700 MHz is much lower compared to the fundamental mixer. Yet, its' level is still high enough to degrade the performance of a communications link.

Similarly down-conversion of a signal occupying a band of 29,500-30,000 MHz to 19,700-20,200 MHz would require a LO frequency of 9,800 MHz and it's second harmonic would only be 100 MHz away from the output band edge which is similar to the above case. As before, a subharmonic mixer would be preferable here also. While the level of the LO signal for the subharmonic conversion case would be lower than the fundamental frequency conversion case, the reduction of the LO spur level to the desirable levels is still very difficult and expensive.

Referring to FIG. 2, a block diagram of a subharmonic carrier-canceling baseband/K upconverter system 18 according to the present invention is illustrated. System 18 uses a first splitter 20 to split an incoming RF signal into two equal components: in-phase (I) and quadrature (Q, 180 degrees delayed). First splitter 20 is typically implemented as a standard microwave hybrid transformer. First splitter 20 includes a first splitter input 22 for receiving the incoming radio signal, a first splitter I output 24 for generating a first splitter I signal, and a first splitter Q output 26 for generating a first splitter Q signal.

System 18 also uses a second splitter 28 to split a local oscillator signal into two equal components: in-phase (I) and quadrature (Q, 90 degrees delayed). Second splitter 28 is typically implemented as a standard microwave hybrid transformer. Second splitter 28 includes a second splitter input 30 for receiving the local oscillator signal, a second splitter I output 32 for generating a second splitter I signal, and a second splitter Q output 34 for generating a second splitter Q signal.

The I signals from both splitters 20, 28 then pass through a first subharmonic mixer 36 while the Q signals from both splitters 20, 28 passes through a second subharmonic mixer 38. After passing through the first and second subharmonic mixers 36, 38, the resulting signals are combined using a combiner 40. Combiner 40 includes a first combiner input 42 for receiving the I signals from first subharmonic mixer 36, a second combiner input 44 for receiving the Q signals from first subharmonic mixer 36, and a combiner output 46 for generating a radio frequency output.

Referring to FIG. 3, a block diagram of an alternative subharmonic carrier-canceling baseband/K upconverter system 18′ according to the present invention is illustrated. System 18′ uses a second splitter 28 to split a local oscillator signal into two equal components: in-phase (I) and quadrature (Q, ninety degrees delayed). Second splitter 28 is typically implemented as a standard microwave hybrid transformer. Second splitter 28 includes a second splitter input 30 for receiving the local oscillator signal, a second splitter I output 32 for generating a second splitter I signal, and a second splitter Q output 34 for generating a second splitter Q signal.

The I signal from second splitter 28 is coupled directly to an incoming RF signal, which then passes through a first subharmonic mixer 36 while the Q signal from splitter 28 passes through a second subharmonic mixer 38. After passing through the first and second subharmonic mixers 36, 38, the resulting signals are combined using a combiner 40. Combiner 40 includes a first combiner input 42 for receiving the I signal from first subharmonic mixer 36, a second combiner input 44 for receiving the Q signal from first subharmonic mixer 36, and a combiner output 46 for generating a radio frequency output.

The present invention thus demonstrates an improved subharmonic carrier-canceling baseband/K upconverter system by combining subharmonic mixing with spur cancellation. In this way, the present invention allows inexpensive filtering of second order harmonics close to a local oscillator frequency.

From the foregoing, it can be seen that there has been brought to the art a new and improved subharmonic carrier-canceling baseband/K upconverter system system. It is to be understood that the preceding description of the preferred embodiment is merely illustrative of some of the many specific embodiments that represent applications of the principles of the present invention. Clearly, numerous and other arrangements would be evident to those skilled in the art without departing from the scope of the invention as defined by the following claims.

What is claimed is:

1. A subharmonic carrier-canceling apparatus for filtering out second order harmonics close to a local oscillator frequency from an incoming RF signal, said linearizer comprising:
a first splitter having a first splitter input, a first splitter I output, and a first splitter Q output, said first splitter input receiving said incoming RF signal, said first splitter separating said incoming RF signal into a first splitter in-phase (I) signal carried by said first splitter I output, and a first splitter quadrature (Q) signal carried by said first splitter Q output, wherein said first splitter Q signal is delayed 180 degrees behind said first splitter I signal;
a second splitter having a second splitter input, a second splitter I output, and a second splitter Q output, said second splitter input receiving a local oscillator signal, said second splitter separating said local oscillator signal into a second splitter in-phase (I) signal carried by said second splitter I output, and a second splitter quadrature (Q) signal carried by said second splitter Q output, wherein said second splitter Q signal is delayed 90 degrees behind said second splitter I signal;
a first subharmonic mixer coupled to said first splitter I output and said second splitter I output and receiving said first splitter I signal and said second splitter I signal, said first harmonic mixer generating a first mixer signal;
a second subharmonic mixer coupled to said first splitter Q output and said second splitter Q output and receiving said first splitter Q signal and said second splitter Q signal, said second harmonic mixer generating a second mixer signal; and
a combiner coupled to said first and second subharmonic mixers and receiving said first and second mixer signals, said combiner combining said mixer signals to generate an output RF signal having reduced second order harmonics close to said local oscillator frequency.

2. The subharmonic carrier-canceling apparatus for filtering out second order harmonics close to a local oscillator frequency from an incoming RF signal as recited in claim 1, wherein said first splitter comprises a microwave hybrid transformer.

3. The subharmonic carrier-canceling apparatus for filtering out second order harmonics close to a local oscillator frequency from an incoming RF signal as recited in claim 1, wherein said second splitter comprises a microwave hybrid transformer.

4. A subharmonic carrier-canceling apparatus for filtering out second order harmonics close to a local oscillator frequency from an incoming RF signal, said linearizer comprising:
a first splitter having a first splitter input, a first splitter I output, and a first splitter Q output, said first splitter input receiving a local oscillator signal, said first splitter separating said local oscillator signal into a first splitter in-phase (I) signal carried by said first splitter I output, and a first splitter quadrature (Q) signal carried by said first splitter Q output, wherein said first splitter Q signal is delayed 90 degrees behind said first splitter I signal;
a first subharmonic mixer coupled to said first splitter I output and receiving said first splitter I signal and said incoming radio signal, said first harmonic mixer generating a first mixer signal;
a second subharmonic mixer coupled to said first splitter Q output and receiving said first splitter Q signal, said second harmonic mixer generating a second mixer signal; and
a combiner coupled to said first and second subharmonic mixers and receiving said first and second mixer signals, said combiner combining said mixer signals to generate an output RF signal having reduced second order harmonics close to said local oscillator frequency.

5. The subharmonic carrier-canceling apparatus for filtering out second order harmonics close to a local oscillator frequency from an incoming RF signal as recited in claim 4, further comprising a second splitter having a second splitter input, a second splitter I output, and a second splitter Q output, said second splitter input receiving said incoming RF signal, said second splitter separating said incoming RF signal into a second splitter in-phase (I) signal carried by said second splitter I output, and a second splitter quadrature (Q) signal carried by said second splitter Q output, wherein said second splitter Q signal is delayed 180 degrees behind said second splitter I signal;

6. The subharmonic carrier-canceling apparatus for filtering out second order harmonics close to a local oscillator frequency from an incoming RF signal as recited in claim 4, wherein said first splitter comprises a microwave hybrid transformer.

7. The subharmonic carrier-canceling apparatus for filtering out second order harmonics close to a local oscillator frequency from an incoming RF signal as recited in claim 5, wherein said second splitter comprises a microwave hybrid transformer.

8. A satellite communications system, comprising:
a ground station;
a satellite in orbit and in communication with said ground station, said satellite having a subharmonic carrier-canceling apparatus for filtering out second order harmonics close to a local oscillator frequency from an incoming RF signal comprising:
a first splitter having a first splitter input, a first splitter I output, and a first splitter Q output, said first splitter input receiving said incoming RF signal, said first splitter separating said incoming RF signal into a first splitter in-phase (I) signal carried by said first splitter I output, and a first splitter quadrature (Q) signal carried by said first splitter Q output, wherein said first splitter Q signal is delayed 180 degrees behind said first splitter I signal;
a second splitter having a second splitter input, a second splitter I output, and a second splitter Q output, said second splitter input receiving a local oscillator signal, said second splitter separating said local oscillator signal into a second splitter in-phase (I) signal carried by said second splitter I output, and a second splitter quadrature (Q) signal carried by said second splitter Q output, wherein said second splitter Q signal is delayed 90 degrees behind said second splitter I signal;
a first subharmonic mixer coupled to said first splitter I output and said second splitter I output and receiving said first splitter I signal and said second splitter I signal, said first harmonic mixer generating a first mixer signal;
a second subharmonic mixer coupled to said first splitter Q output and said second splitter Q output and receiving said first splitter Q signal and said second splitter Q signal, said second harmonic mixer generating a second mixer signal; and
a combiner coupled to said first and second subharmonic mixers and receiving said first and second mixer signals, said combiner combining said mixer signals to generate an output RF signal having reduced second order harmonics close to said local oscillator frequency.

9. The satellite communications system as recited in claim 8, wherein said first splitter comprises a microwave hybrid transformer.

10. The satellite communications system as recited in claim 8, wherein said second splitter comprises a microwave hybrid transformer.

11. A satellite communications system, comprising:
a ground station;
a satellite in orbit and in communication with said ground station, said satellite having a subharmonic carrier-canceling apparatus for filtering out second order harmonics close to a local oscillator frequency from an incoming RF signal comprising:
a first splitter having a first splitter input, a first splitter I output, and a first splitter Q output, said first splitter input receiving a local oscillator signal, said first splitter separating said local oscillator signal into a first splitter in-phase (I) signal carried by said first splitter I output, and a first splitter quadrature (Q) signal carried by said first splitter Q output, wherein said first splitter Q signal is delayed 90 degrees behind said first splitter I signal;
a first subharmonic mixer coupled to said first splitter I output and receiving said first splitter I signal and said incoming radio signal, said first harmonic mixer generating a first mixer signal;
a second subharmonic mixer coupled to said first splitter Q output and receiving said first splitter Q signal, said second harmonic mixer generating a second mixer signal; and
a combiner coupled to said first and second subharmonic mixers and receiving said first and second mixer signals, said combiner combining said mixer signals to generate an output RF signal having reduced second order harmonics close to said local oscillator frequency.

12. The satellite communications system as recited in claim 11, further comprising a second splitter having a second splitter input, a second splitter I output, and a second splitter Q output, said second splitter input receiving said incoming RF signal, said second splitter separating said incoming RF signal into a second splitter in-phase (I) signal carried by said second splitter I output, and a second splitter quadrature (Q) signal carried by said second splitter Q output, wherein said second splitter Q signal is delayed 180 degrees behind said second splitter I signal;

13. The satellite communications system as recited in claim 11, wherein said first splitter comprises a microwave hybrid transformer.

14. The satellite communications system as recited in claim 12, wherein said second splitter comprises a microwave hybrid transformer.
